(19) United States
(12) Patent Application Publication
(10) Pub. No.: US 2011/0303193 A1
(43) Pub. Date: Dec. 15, 2011

(54) HIGH EFFICIENCY INTERNAL COMBUSTION ENGINE

(76) Inventor: Shailendra Kumar Singh, Allahabad (IN)

(21) Appl. No.: 12/961,158

(22) Filed: Dec. 6, 2010

(30) Foreign Application Priority Data
Dec. 16, 2009 (IN) 2628/DEL/2009

(51) Int. Cl. F02B 75/04; F02D 15/02

(52) U.S. Cl. 123/48 B

(57) ABSTRACT

The present invention is an improved high efficiency internal combustion engine (IHEICE) which results in higher efficiency due to its design, or respective relation of its parts. In the IHEICE, the energy fuel produced after combustion is harnessed and exploited to its highest potential when the engine starts exploiting the power after extended Top Down Center (ETDC). The main improvement in the IHEICE is the fitting and arrangement of the piston connecting rod and the crank; that is, the arrangement of the piston with respect to the crank, with the internal fitting design being the same. In the traditional arrangement, a problem is created in exploiting power from 60 degrees and beyond because a displacement (gap) is created inside the head resulting from the downward movement of the piston (60 degree movement of the crank). To fill this gap, the connecting rod, with a timer/cam and wheels, is used.

### CROSS-REFERENCE TO RELATED APPLICATION

This application claims the benefit of the priority filing date in Indian Patent Application No. 2628/DEL/2009 filed on Dec. 16, 2009. The earliest priority date claimed is Dec. 16, 2009.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to an improvement resulting in a tremendous increase in the efficiency of the conventional internal combustion engine (CICE) as demonstrated in a new design and parts changes. The harnessing of the maximum possible energy of fuel has not been possible until now, through a new design of the CICE. The design is more eco-friendly. The emission of hazardous gases responsible for the green house effect would be curtailed drastically in the same proportion as fuel savings are improved, which is approximately more than 66 percent in the automobile industry.

Prior art: The conventional engine has a block head fitted to a chamber sheet in such a way that the center of the piston, the connecting rod and the crank center are in one line, i.e., the axis of the crank and the cylinder when the crank is at Top Dead Center (TDC) or Bottom Dead Center (BDC). But in the improved high efficiency internal combustion engine (IHEICE), the position of the piston is offset with respect to the axis of the crank. So these parts are never in one line in IHEICE.

All internal combustion engines are bound to have a head block crank and a structure known as chamber sheet to hold the above said parts. So both CICE and IHEICE engines have these parts in common.

The CICE with low efficiency has worked for many centuries and has undergone many modifications. Some improvements in its efficiency have been achieved by improving the burning percentage of fuel during combustion, but fundamental changes as in the present invention have not been possible thus far. In the CICE, large amounts of fuel energy are lost to the atmosphere in the form of heat energy through conduction, radiation and exhaust. Precious fuels required in mechanical movements and imported from foreign countries are wasted because of the CICE's low efficiency. The present invention drastically reduces the emission of hazardous gases, while reducing energy loss to the greatest extent possible, thereby resulting in fuel energy savings with less harm to the environment.

Important objects of the present invention include a drastic savings of precious fuels and the generation of high torque using a small size internal combustion engine.

A further important object of the present invention is a drastic reduction of hazardous gas emissions.

Another further important object of the present invention is to get, in the area of gasoline (petrol), diesel and gas, the most efficient internal combustion engine possible that can utilize the most fuel energy generated after combustion.

In more precise terms, the main object of the present invention is to exploit up to approximately 66% or more of fuel energy, in contrast to the present level of 26%, out of which 60% reaches the wheels, in contrast to the present 20%. This represents a 200% or greater improvement in the efficiency of the internal combustion engine.

The second main object of the present invention is to make the CICE more eco-friendly by substantially reducing the emission of hazardous gases, such as carbon monoxide.

Another main object of the present invention is to get a more powerful IC engine using a smaller size (or parameters) by improving the torque generated within the same parameters.

Finally, the invention seeks to minimize the internal frictional loss by reducing the side thrust during the power stroke substantially less than the CICE's side thrust. In the improved high efficiency internal combustion engine (IHEICE), the angle between the pressure generated and pressure applied on the crank, through the connecting rod on the crank arm, will be substantially less than that in the CICE. The factor responsible for the side thrust is the sine of the angle.

The wear and tear resulting from the side thrust would be substantially decreased, thereby resulting in time, material and money savings.

These objects are important with respect to heavy machines, such as rail engines.

### SUMMARY

The present invention is an improved high efficiency internal combustion engine (IHEICE) which results in higher efficiency due to its design, or respective relation of its parts, i.e., the crank and piston. In conventional settings, the arm at the starting point [TDC] is zero so that the driving component is zero, and the energy fuel produced after combustion is never exploited or harnessed completely when the engine starts exploiting the power after TDC. However, in the IHEICE, the energy fuel produced after combustion is harnessed and exploited to its highest potential when the engine starts exploiting the power after extended Top Down Center (ETDC).

The main improvement in the IHEICE is the fitting and arrangement of the piston connecting rod and the crank; that is, the arrangement of the piston with respect to the crank as shown in FIG. 1 with the internal fitting design being the same. In the traditional arrangement, a problem is created in exploiting power from 60 degrees and beyond because a displacement (gap) is created inside the head resulting from the downward movement of the piston (60 degree movement of the crank). To fill this gap, the connecting rod, with a timer/cam and wheels, is used.

Connecting rods, cranks with a crank plate, and pistons are used conventionally. Only their design is changed slightly as shown in the figures. Each part's parameters change in accordance with the size of the engine.

For example, assuming a gap of 9 mm is created inside head for the IHEICE. The timer would have to lift the piston from a TDC to 60 degree 9 mm so that the piston's linear movement is zero with respect to the angular movement of the crank up to the 60 degree. Hence, the outer height of the cam/timer would be 9 mm and the inner hole would be in accordance with the diameter of the crank pin. This is applicable only when the bore and stroke of the engine is 50 mm. With a change in the bore and stroke, the parameters would change.

In actuality, the internal combustion (IC) Engine is only made of certain parts, i.e., the crank, the connecting rod, the piston and the magnet with a system of controlling the ignition point and a structure to hold these parts as desired and in accordance with the probable results. When we change this arrangement as in the IHEICE, the improvement in the results is astonishing.

### DRAWINGS

FIG. 1: shows the position of the crank and connecting rod after fitting when the crank has moved 90 degree from its zero position or approx 70 degrees from the Extended Top Dead Center [ETDC].

FIG. 2: shows the cut/space (8) in the bottom of the piston so that movement of the connecting rod is not blocked during the compression stroke.

FIG. 3: shows the cut/space in the bottom of the liner (9) so that movement of the connecting rod is not blocked or obstructed during the compression stroke.

FIG. 4: shows the crank-plate (10) with crank arm

FIG. 5: shows the design of the cam/timer [11,12,13,14].

FIG. 6: shows the crank arm in the crank-plate fitted with a cam/timer.

FIG. 7: shows the connecting rod with four holes [15,16,17,18] to be fitted with different parts

FIG. 8: shows the pair of wheels to be fitted in the connecting rod in holes no. 16 and 18.

Diagram no-1: shows the position of the connecting rod, piston, crank arm, etc., fitted internally in the IHEICE.

Diagram no-2: shows the position of the connecting rod, piston, crank arm, etc., fitted Internally for the CICE.

Diagram no-3: shows the forces generated in the CICE after combustion and their angles

Diagram no-4: shows the forces generated in IHEICE after combustion and their angles.

### DETAILED DESCRIPTION

The present invention relates to an improved high efficiency internal combustion engine [IHEICE] wherein the improvement is capable of utilizing the maximum possible energy out of the energy generated after combustion of the fuel inside the head irrespective of the fuel used. The existing or conventional internal combustion engine (CICE) loses a major portion of heat energy produced after combustion inside the head in the form of conduction radiation and exhaust, as well as internal friction.

When the pressure inside the head is at its maximum, the driving force component of that pressure, which rotates the crank, is the sine value of the angle, which the connecting rod makes with center of the crank or the horizontal axis of the crank, and that angle at the aforesaid position is approximately zero, increasing gradually with the movement of the crank in CICE. The sine value for zero is zero and increasing there from. At 10 degrees, the maximum force inside the head is achieved in the CICE with a corresponding increase in volume. But the sine value of that angle is very small such that a thrust on the body is a major portion of the force generated, and the driving force responsible for the mechanical work (efficiency) is very small, as given in diagram-3.

The maximum driving force in the CICE is approximately a 30 degree [angle A diagram-3] movement of the crank, and thereafter decreases with displacement of the piston. The full possible value of the pressure generated inside the head is never converted into mechanical work and the major portion of the energy is lost to the atmosphere.

In the CICE, when the driving force factor reaches its maximum, the pressure inside the head minimizes displacement; however, more pressure cannot be created for the opposing forces of the compression stroke. This negates efficiency.

Different fuels take different times to complete combustion due to the design mode and position point of the ignition. Thus, minor changes are required in the design for different fuels and their respective use. However, the main design with its main parts would be the same. The present discussion relates to engines using petrol as fuel.

Petrol takes approximately a 68 degree time of crank movement in completing combustion for a single point ignition at the normal (suggested) rpm in an engine at maximum efficiency. The time would be the same but the degree would be different depending on the design. To a certain extent, energy is used by the CICE in the time it takes to complete the combustion or burning of the fuel, and the rest is wasted in the form of exhaust, conduction and radiation. Because the ignition in the CICE single point is at 20 degree before the TDC, the volume starts increasing after 20 degrees and full pressure is never created. Heat energy is wasted mainly in the form of exhaust. This mechanical fault is mainly responsible for the low efficiency of the CICE.

Approximately 37% of heat energy loss is due to conduction and radiation, 37% due to exhaust, and 6% due to frictional internal loss. Figures for heat energy loss may differ slightly for different engines. Approximately, 20% of heat energy reaches the wheels.

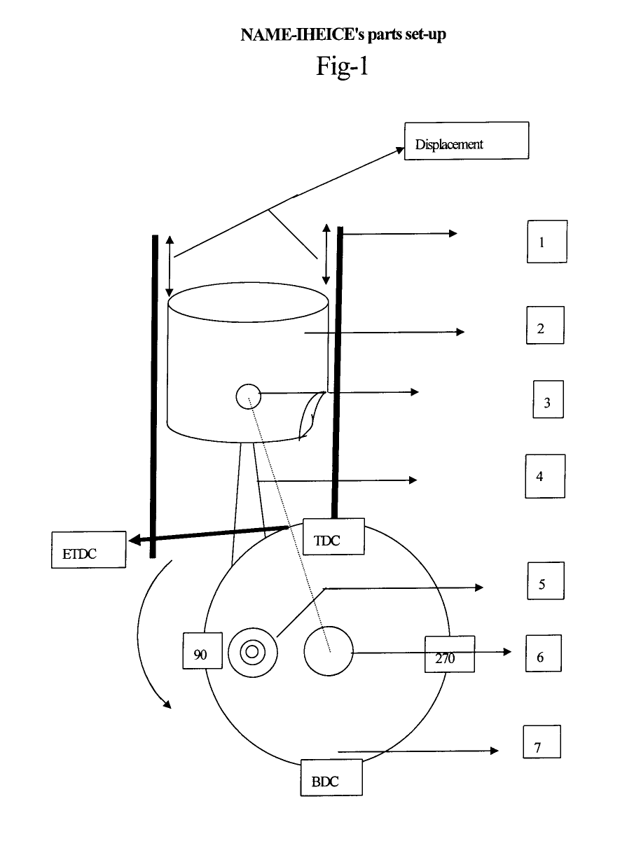

The invention is characterized in that, in the design of an IHEICE, the head block and chamber sheet are fitted to each other such that, when the crank moves 90 degree from its zero position (traditional TDC), the angle between the connecting rod and the crank arm is at a right angle or at 90 degrees, as shown in FIG. 1, written as IHEICE (1, 4). For the purpose of the new block design, a liner, a piston, a crank and a chamber sheet will be required.

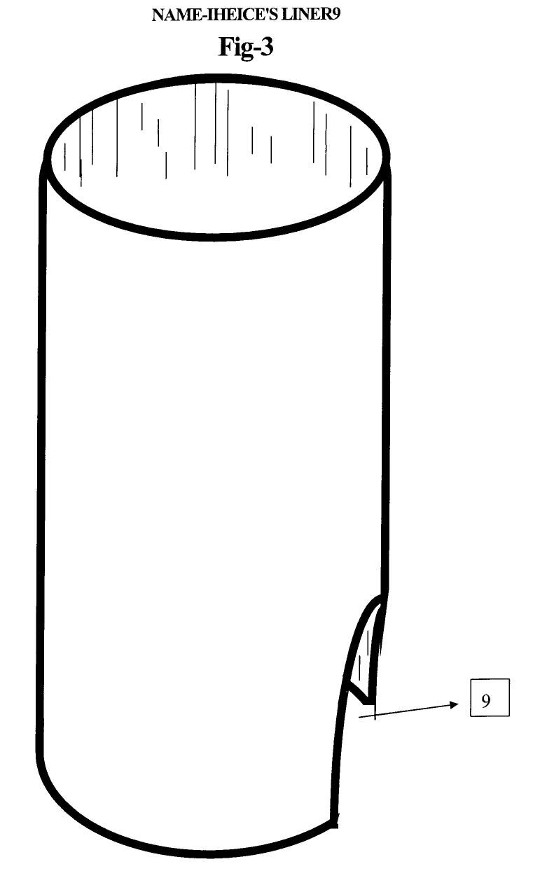

The liner would have a space in the base (9) so that movement of the connecting rod during the compression stroke is possible, as shown in FIG. 3.

Similarly, the piston would need changes in the same fashion in the form of a cut or space in the base (8) so that during the compression stroke the piston does not create an obstacle to the movement of the connecting rod.

The mechanism details for covering the displacement due to the crank's movement up to 60 degrees, where we start the exploitation of the power/pressure generated after combustion, is as follows:

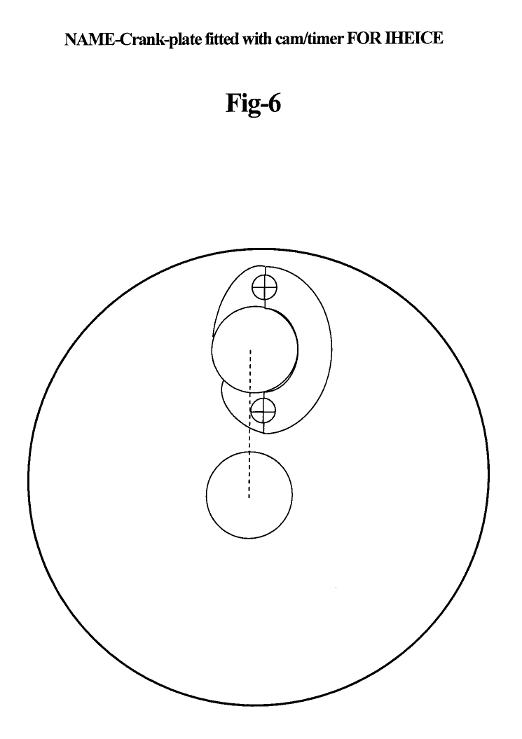

1. Two timer/cams are fitted to both inner sides of the crank plate so that they can manipulate the movement of the connecting rod as shown in the FIG. 6.

The timer/cam's parameters are designed so that they manipulate the piston with the help of the connecting rod, to stand still up to a position of 60 degrees of crank movement starting from the position of the crank at the ETDC of the IHEICE. This is where we start exploiting the power of the pressure in the form of torque. The timer/cam is fitted with the crank plate so that it can be changed after wear and tear over time.

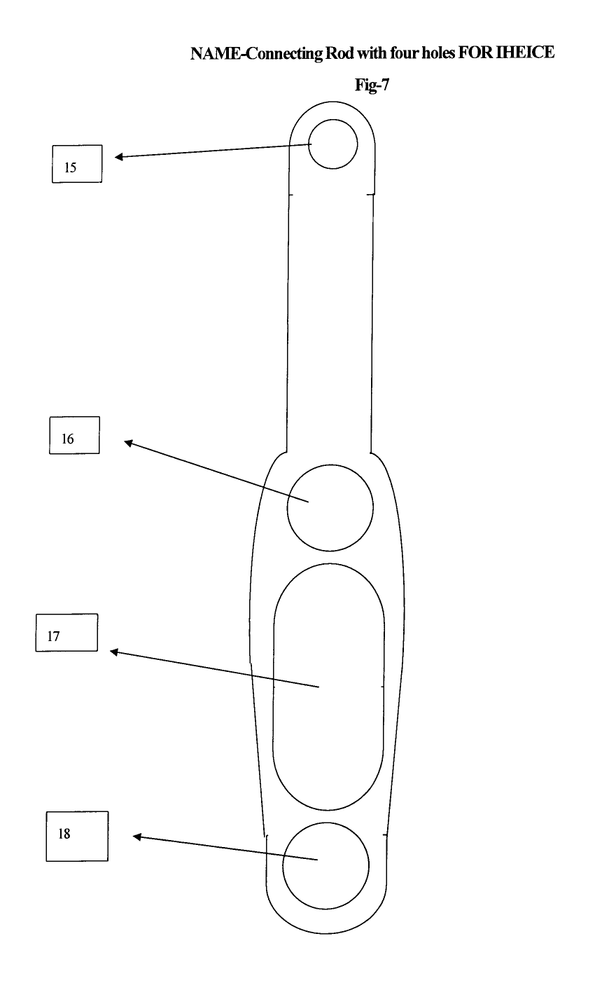

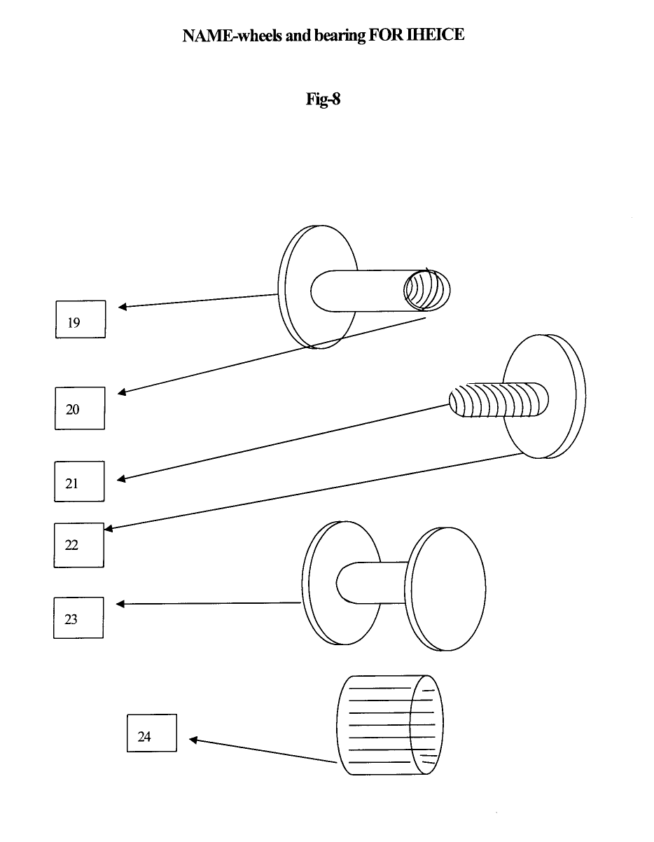

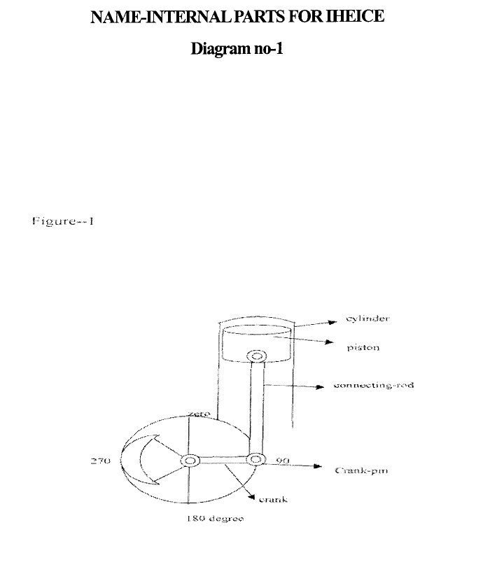

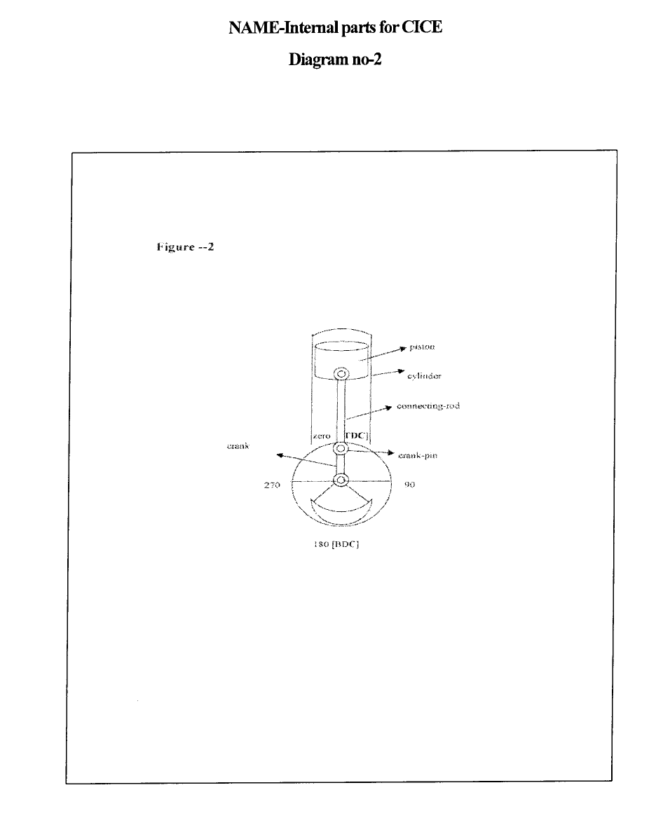

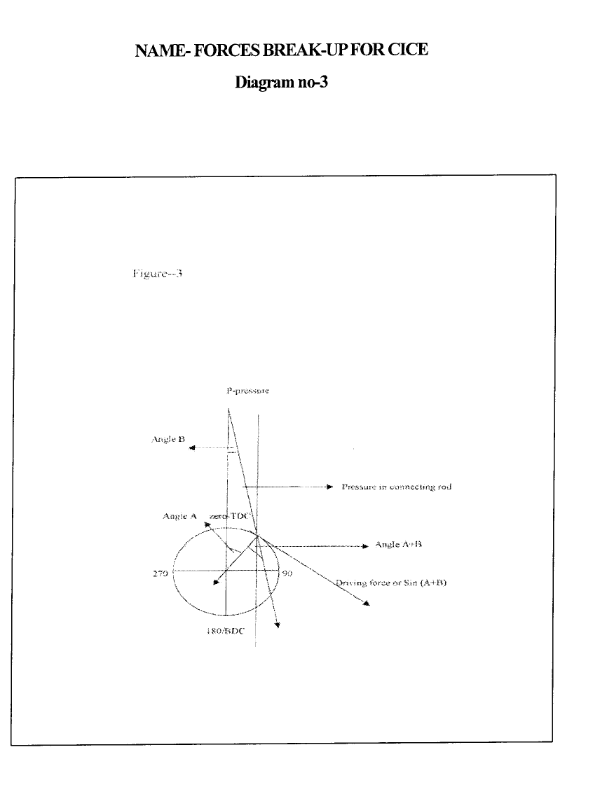

2. The connecting rod is redesigned that there are 4 holes in it. Three holes are circular in shape and one is substantially elliptical. The holes are identified as 15, 16, 17 and 18 in FIG. 7.

Point-15—Hole for the purpose of connecting the piston to the connecting rod with the help of the Gudgeon-pinion.
Point-16—Hole for a pair of wheels and bearings which would run on the timer/cam.
Point-17—Hole, substantially elliptical, for the crank pin and bush/bearing.
Point-18—Another Hole for a pair of wheels and corresponding bearing.

The ignition in the engine starts at 25 degrees before the zero degree position of the crank in the traditional TDC, or 45 degrees before the Extended TDC of the IHEICE. In the IHEICE, the TDC constitutes 20 degree of crank movement, named Extended TDC (ETDC). The stroke length of the IHEICE is different in comparison to the stroke length of the CICE.

The carburetor would also need changes with respect to the hole supplying the fuel and the sliding rod controlling the fuel supply for the accelerator. The hole controlling the fuel supply in stand-by mode would also be small in size.

Therefore, the present invention is illustrated with reference to the foregoing drawings showing an improved high efficiency internal combustion engine characterized in that the piston (2), as shown in FIG. 1, is on a “y” axis and the center of the crank (6) is at an “x” axis, and the angle between them remains at 90 degrees irrespective of the crank or piston movement, which is said to be a piston off-set with respect to the center of the crank.

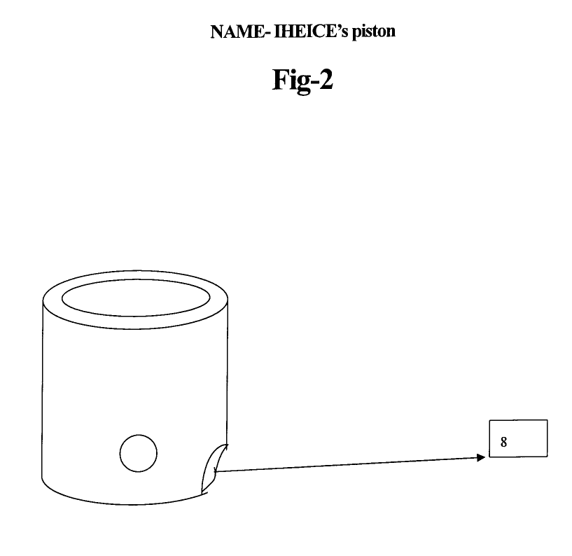

In a further embodiment of the present invention, the inventive engine gets obstructed during movement from the extended bottom dead center (EBDC) to the ETDC. The connecting rod is obstructed by the piston while in movement. To avoid the obstruction, the piston (2) has a cut at its base (8) as shown in FIGS. 1 and 2. The shape and size of the cut depends on the shape and size of the area between (15) and (16) of the connecting rod, as shown in FIG. 7.

A further embodiment of the present invention is illustrated in the following scenario, wherein a piston (2) moves inside the liner (1) [FIG. 1] and while in movement is obstructed by the connecting rod [FIG. 7] when the crank moves from the EBDC to ETDC. Consequently, the liner also obstructs the movement of the crank-plates, as shown in FIG. 1. To avoid this obstruction, the liner (1) is modified with a cut space (9) [FIG. 3] at the base of the liner. The shape and size of the cut space (9) would depend on the shape and size of the new connecting rod, as shown in FIG. 7. The shape and size of the cut/space also depends on the type of engine, i.e whether the engine has a crank-plate or not also depends on the shape and size of the crank-plates, as shown in FIG. 1.

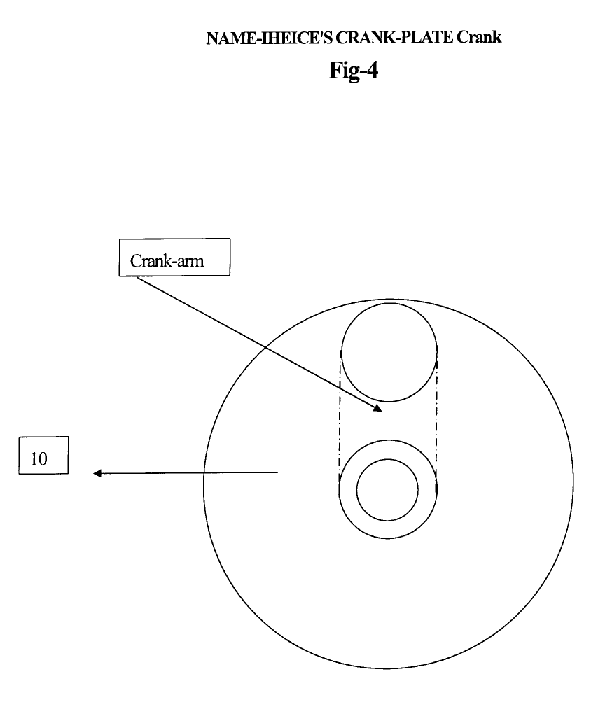

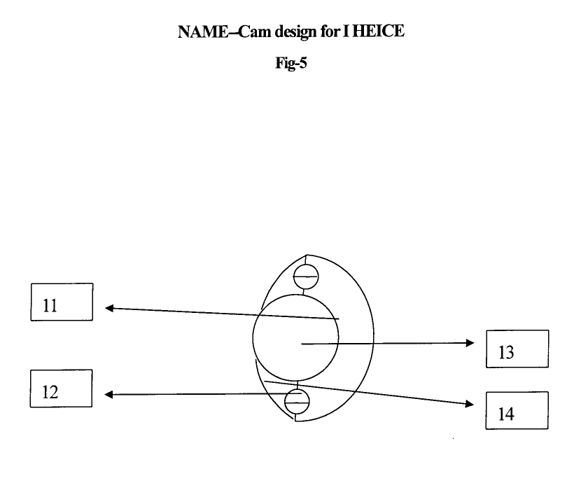

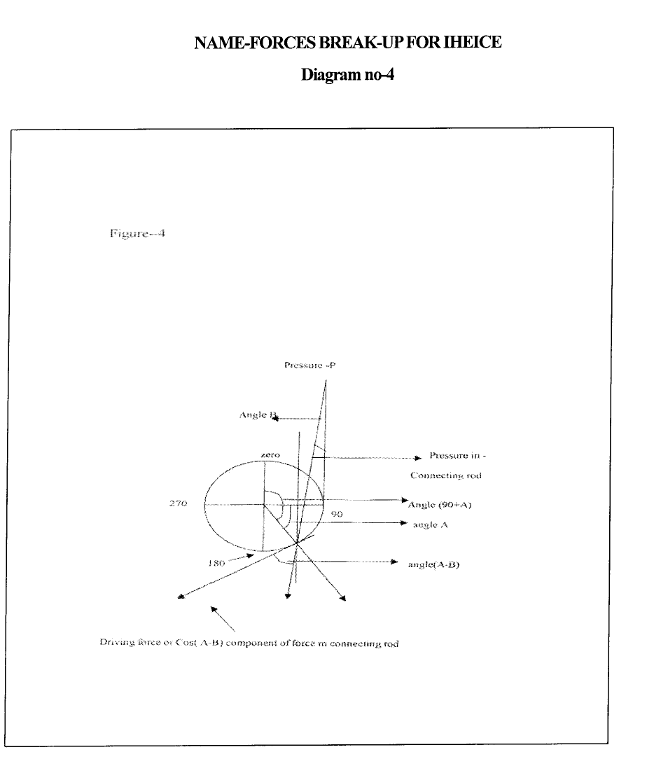

A further embodiment of the present invention is that the crank plates at the hole (5) [FIG. 1] or at the end point of the arm of the crank [FIG. 4] has a different design. This is because some engines use a separated flywheel in lieu of a crank plate. Thus, the timer/cam, as shown in FIGS. 5 and 6, on which the wheels (23) [FIG. 8] fitted with the connecting rod move, may have a slightly different design and fittings. The slope of the timer/cam is designed such that when the upper wheel of the connecting rod descends to the timer/cam, the lower wheel ascends up the timer/cam. The height of the timer/cam depends on the bore and stroke of the engine and would differ with every engine because the height of the timer/cam serves to cover the displacement of the piston inside the liner.

A new connecting rod is shown in FIG. 7, wherein the design of the engine would create a displacement which would lower the compression-ratio for a new ignition degree. To achieve that, the piston would have to stay at the top position of its height up to a desired degree of crank movement harmonious with the ignition option for which the new connecting rod (4) [FIG. 1] is modified with four holes [FIG. 7]. Three holes (15) (16) (18) are circular in shape, as shown in FIG. 7, and one hole (17) is elliptical in shape. Hole (15) is for joining the connecting rod with the piston with the help of a gudgeon-pinion. Holes (16) and (18) are for the pair of wheels (23) [FIG. 8]. The wheels are fitted in the holes with the help of the bearings (24) [FIG. 8]. Hole (17) is for the accommodation of the bearing/bush with the crank-pinion. The connecting rod, with the help of hole (17), would slide over the crank-pinion bearing/bush harmonious with the position of the pair of wheels on the timer/cam in accordance with the movement of the crank.

In a further embodiment of the present invention, the pair of wheels are made in two parts (19),(20),(21),(22), as shown in FIG. 8. They could be attached to the connecting rod with the help of the bearing/bush (24). The wheels are fashioned together with the help of threads of the axle of the wheels (20) (21), as shown in FIG. 8, with the bearing inside and the entire set inside holes (16) and (18) of the connecting rod.

Advantages of the present invention:

1. A new generation of IC Engines with high efficiency would be possible.
2. Fuel would be saved by as much as 66% of present consumption.
3. The engine becomes eco friendly as the IHEICE emits substantially low level of hazardous gases.
4. A high power engine of small size would be possible
5. The wear and tear to the piston and liner would be reduced substantially for the lower side thrust.
6. Aircrafts would become highly efficient as the weight of the engine would be curtailed substantially.
7. Many machines would have new meaning owing to their new design's high pick-up.
8. A new generation of carburetors would become standard requirement.
9. Machines would be efficient at high rpms in comparison to the CICE, and new gear boxes having a new meaning would come into existence.
10. Total internal friction would decrease for substantially vertical settings of the connecting rod in the power stroke.

Process: The carburetor would supply approximately ⅓^{rd} of the fuel per combustion in the IHEICE as compared to the fuel required in the CICE in the intake stroke. The fuel mixed air would be compressed in the compression stroke up to the ETDC, but the ignition would take place at about 45 degree before the ETDC of the IHEICE. After the ETDC of the IHEICE in the power stroke, the piston would stand at rest for the next 40 degrees so that the crank rotates up to the 60 degree position where we start exploiting the power when the piston starts a linear downward movement resulting from the pressure exerted on the connecting rod generated after combustion. At this time, the fuel is burnt completely and the heat energy need only radiate and conduct through metal. The displacement for these degrees is gradually increasing and sufficiently large in comparison to the CICE. Thus, the heat energy is absorbed and used more than in the CICE for conversion to mechanical work

Finally, the exhaust stroke takes place and gases are released to the atmosphere.

In this design, at the starting point, the driving force component is sine 60=0.866, while in the CICE, it is zero. [Of the pressure inside the head]

After 60 degrees of crank movement, the displacement of the piston is large for a similar degree angular movement of the crank and gradually increases up to the center. As such, the time of linear movement of the piston is saved, and maximum pressure is created. We then get the maximum possible efficiency of the IC engine.

In this process, the exploited torque is roughly more than three times the torque generated in the CICE for the same fuel amount, and the energy that would be lost the atmosphere is trapped and used for mechanical work.

1. An improved high efficiency internal combustion engine, characterized in that a piston (2) is off-set with respect to a center of a crank arranged, as shown in FIG. 1 wherein, if the piston is on a “y” axis and the center of the crank (6) is at an “x” axis, the angle between them becomes 90 degrees irrespective of crank or piston movement, a liner (1) is modified with a cut space (9) [FIG. 3] at the base of the liner, a crank plate is arranged at a hole (5) [FIG. 1], or at the end point of an arm of the crank [FIG. 4] if a separated flywheel is used in place of a crank plate, a timer/cam, as shown in FIGS. 5 and 6, on which wheels 23 fitted in holes (16) and (18) of a connecting rod create a movement, a new connecting rod (4) is modified, as shown in FIG. 7, to cover a displacement lowering the compression-ratio for a new ignition degree to cover the position of its height up to a desired degree of movement, a pair of wheels are made in two parts (19),(20),(21),(22), as shown in FIG. 8, attached to the connecting rod with the help of a bearing/bush (24), as shown in FIG. 8.

2. The improved combustion engine as claimed in claim 1, wherein the piston (2) has a cut at its base (8), as shown in FIG. 1) and FIG. 2), to avoid obstruction.

3. The improved combustion engine claimed in claim 1 wherein the shape and size of the cut depends on the shape and size of the area between holes (15) and (16) of the connecting rod as shown in FIG. 7).

4. The improved combustion engine claimed in claim 2 wherein the shape and size of the cut depends on the shape and size of the area between holes (15) and (16) of the connecting rod as shown in FIG. 7).

5. The improved combustion engine as claimed in claim 1, wherein the shape and size of the cut space (9) of the liner depends on the shape and size of the new connecting rod, as shown in FIG. 7), the shape and size of the cut space also depending on the types of engine, wherein an engine with a crank-plate or without a crank plate also depends on the shape and size of the crank-plate as shown in FIG. 6.

6. The improved combustion engine as claimed in claim 1, wherein a slope of the timer/cam is designed to facilitate the upper wheel of the connecting rod to start descending down the timer/cam, and to facilitate the lower wheel to start going up the timer/cam.

7. The improved combustion engine as claimed in claim 6, wherein the height of the timer/cam depends on the bore and stroke of the engine and differs with every engine as the height of the timer/cam is intended to cover the displacement of the piston inside the liner for the crank's angular movement up to the new point where power is exploited, which is 60 degrees.

8. The improved combustion engine as claimed in claim 1, wherein a new connecting rod, as shown in FIGS. 7 and 1, is modified with four holes, three holes (15), (16), (18), as shown in FIG. 7, being circular in shape and one hole (17) being elliptical in shape, wherein hole (15) is for joining the connecting rod with the piston with the help of a gudgeon-pinion, holes (16) and (18) are for connecting the pair of wheels (23) [FIG. 8] by means of bearings (24) [FIG. 8], and hole (17) is for the accommodation of a bearing/bush with a crank-pinion.

9. The improved combustion engine as claimed in claim 8, wherein the wheels are fashioned together by means of an axle of the wheels (20) (21) as shown in FIG. 8 with the bearing inside and the entire set inside holes (16) and (18) of the connecting rod.

10. The improved combustion engine as claimed in claim 1, wherein the connecting rod with the help of hole (17) slides over the crank-pinion's bearing/bush, harmonious with the position of the pair of wheels on the timer/cam in accordance with the movement of the crank.
